(19) United States
(12) Patent Application Publication
(10) Pub. No.: US 2008/0040773 A1
(43) Pub. Date: Feb. 14, 2008

(54) Policy isolation for network authentication and authorization

(75) Inventors: Majdi AlBadarin, Redmond, WA (US); Xuemei Bao, Issaquah, WA (US); Paul G. Mayfield, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/502,828

(22) Filed: Aug. 11, 2006

(51) Int. Cl. H04L 9/00

(52) U.S. Cl. 726/1

(57) ABSTRACT

Authentication, authorization, and accounting (AAA) operations are performed using policies isolated at application and/or network device level. Categorized policies are generated for applications and network access devices, and provided to a policy database associated with an AAA server. A policy engine evaluates requests for access at application or network access device level. The specific policies are indicated using a network access server type attribute within a policy tag included in a packet from the client. If no applicable policy is found, a default policy may be applied. An adaptive UI enables access to the policies based on user credentials.

### BACKGROUND

As computing devices and services provided by those devices get more and more complex, networks that provide a communication infrastructure for various types of computing devices become also diverse and complicated. Today's typical networks support a wide range of communication types including different types of connections such as a wired connection (e.g., dial-up, ISDN, DSL, cable modem, T1, or the like). Various types of wireless connectivity, including IEEE 802.11 and Bluetooth, are also increasingly popular. Furthermore, a user may connect his or her home computer to an organizational network through a virtual private network (VPN) which creates a secure Internet session between the home computer and the organization's servers.

Services and technologies supported by these networks are also quite diverse. For example, Internet Connection Sharing (ICS) makes it possible for home and small office users to share a single connection to the Internet; Message Queuing (MSMQ) technology enables applications running at different times to communicate across heterogeneous networks and systems that may be temporarily offline; peer-to-peer technologies are used to facilitate real-time communication and collaboration across distributed networks; Internet telephony integrates computers with communications devices and networks; and plug-and-play systems enable dynamic networking of intelligent appliances, wireless devices, and PCs.

It is with respect to these and other considerations that the present invention has been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to providing isolated access policies for applications and network access devices in a networked system. By setting aside a subset of existing policies or creating new ones at application level, packets from applications or network access devices can be evaluated against the custom policies. According to some embodiments, an adaptive user interface (UI) may be presented enabling users to administer policies based on predefined credentials and user-application associations.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates a basic architecture of a network authentication, authorization, and accounting (AAA) system with isolated policies according to embodiments;

FIG. 2 is a block diagram of creation and use of isolated policies in a system according to embodiments;

FIG. 3 is an action diagram illustrating interactions between a user, a network access server (NAS), and an Internet Access Service (IAS) server for creation and use of isolated policies;

FIG. 4 illustrates a networked system where example embodiments may be implemented;

FIG. 5 illustrates use of isolated policies for various scenarios in the networked system of FIG. 4;

FIG. 6 is a block diagram of an example computing operating environment; and

FIG. 7 illustrates a logic flow diagram for a process of using application level policies for authentication, authorization, and accounting in a networked system.

### DETAILED DESCRIPTION

As briefly described above, application and/or network access device level policies may be used to provide users with greater flexibility and security in network access. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

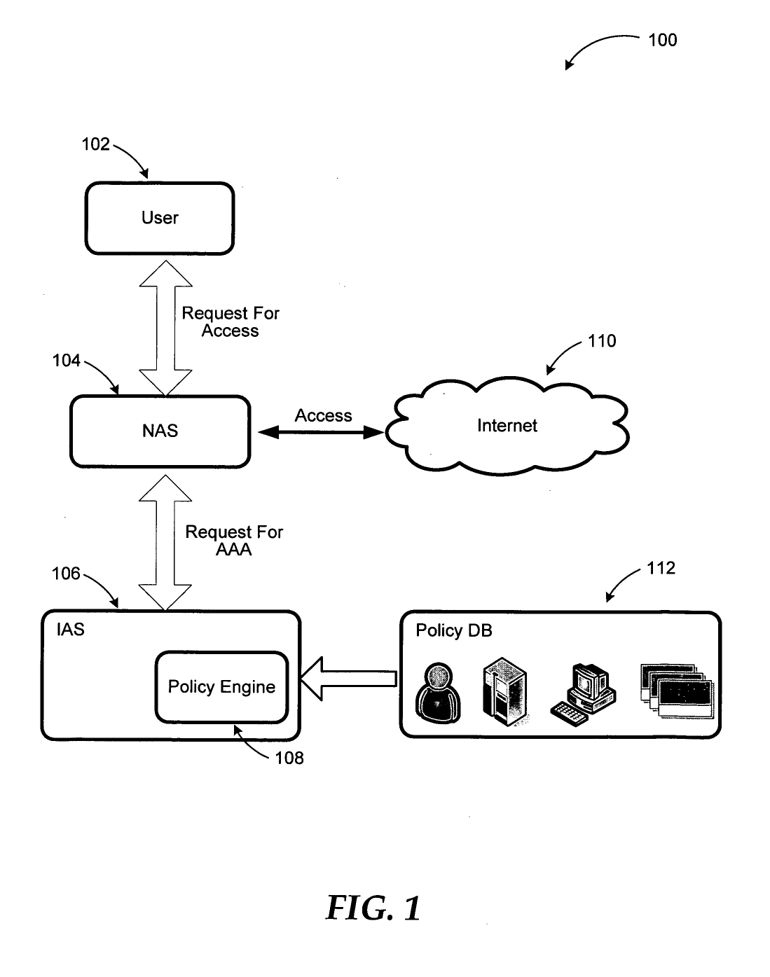

FIG. 1 illustrates a basic architecture 100 of a network authentication, authorization, and accounting (AAA) system with isolated policies according to embodiments. Architecture 100 begins with user 102, which may be a person, a client application, a server, and the like. User 102 may access a network such as Internet 110 and its resources through NAS 104.

In a typical operation, user 102 requests access from NAS 104, which in turn forwards the request to an AAA server such as an Internet Access Service (IAS) server 106. Through an authentication protocol (e.g. Extensible Authentication Protocol), the servers communicate. IAS server 106 may include policy engine 108, which determines one or more applicable policies associated with parameters of the request (user, communication type, access requested resource, etc.). Policy engine 108 may retrieve applicable policy(ies) from policy database 112 for authentication purposes. If the policy engine determines compliance with the applicable policy(ies), IAS server 108 provides an acknowledgement to NAS 106, which in turn facilitates access to the requested network resource (e.g. access to Internet 110) for user 102.

According to some embodiments, policies in policy database 112 may include isolated policies at application and/or network device level. Implementing application level policies instead of user or machine level policies enables a user to obtain access based on different policies for each application. For example, financial transaction applications, such as online banking, may be subject to a higher level of security policies. On the other hand, simpler browsing applications may be subject to lower level security policies. Similarly, the policies may be categorized or isolated based on network access device types. For example, wireless access devices may be subjected to higher level security policies because of concerns about unauthorized use. The policies may also consider a capacity of the network access device setting different rules for dial-up network access devices compared to higher speed DSL or cable type network access devices.

Because the policies may be customized for applications and/or network access devices, not only authentication, but also authorization and accounting operations for the network access may also be performed based on the isolated policies.

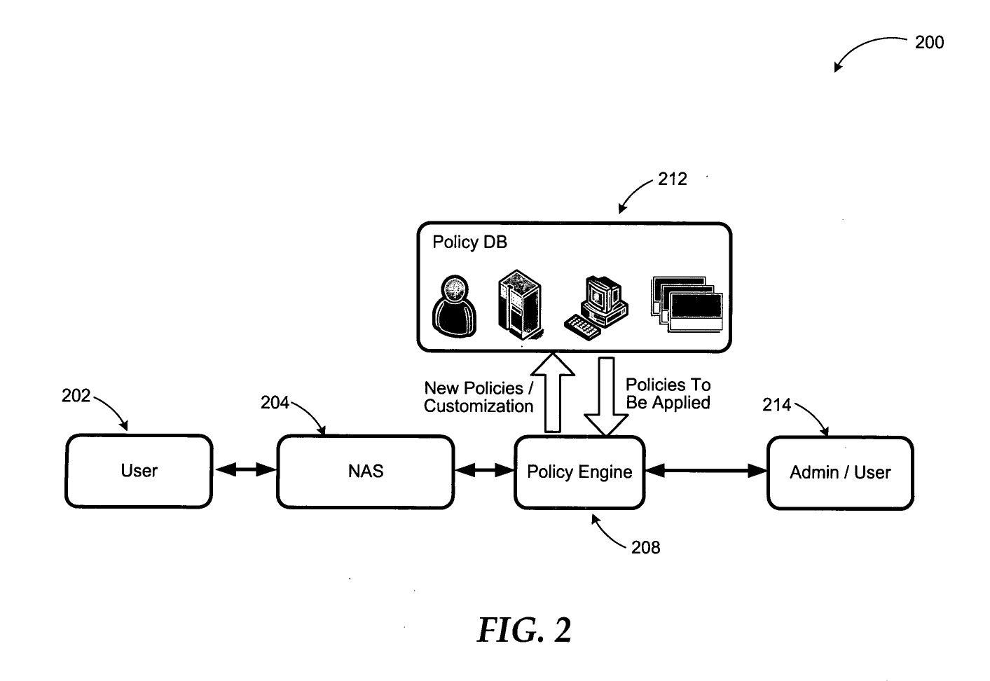

FIG. 2 is a block diagram of creation and use of isolated policies in a system according to embodiments. As mentioned previously, new isolated policies at application and/or network device level may be submitted, existing ones modified or removed as users desire to change their network access configurations.

In a policy creation operation, a user or a network administrator 214 may provide the new isolated policies, modify or remove existing ones using an adaptive UI. The policy management UI may allow access to policies stored in policy database 212 based on the credentials of user or network administrator 214. For example, a user may be associated with a subset of policies applicable to a number of applications related to the user. The adaptive UI may allow access only to that subset of policies based on the user's credentials, while a network administrator may have access to modify all policies stored in policy database 212. User or network administrator 214 may perform the changes through policy engine 208. In other embodiments, the UI for making changes to policy database 212 may be managed by another module or application.

In a use scenario, user 202 submits his/her request for access to NAS 204, which initiates the authentication protocol with an AAA server including policy engine 208. The request may include access to a network or access to a specific network resource (e.g. a data store, an output device, a network application, and the like). Policy engine 208 determines the applicable policy linked to the application or network access device associated with the request, and retrieves the policy from policy database 212. Once the user's compliance with the applicable policy is confirmed, NAS 204 may provide the requested access to user 202.

The architectures discussed in FIG. 1 and FIG. 2 are for illustration purposes only. Embodiments are not limited to the example applications, modules, or processes. Application and/or network access device level policies may be provided in many other ways using the principles described herein. Furthermore, components of an AAA system using isolated policies may be loaded into a server, executed over a distributed network, executed in a client device, and the like. The above described components are for illustration purposes only and do not constitute a limitation on the embodiments. Embodiments may be implemented using fewer or additional components in various orders. Individual components may be separate applications, or part of a single application.

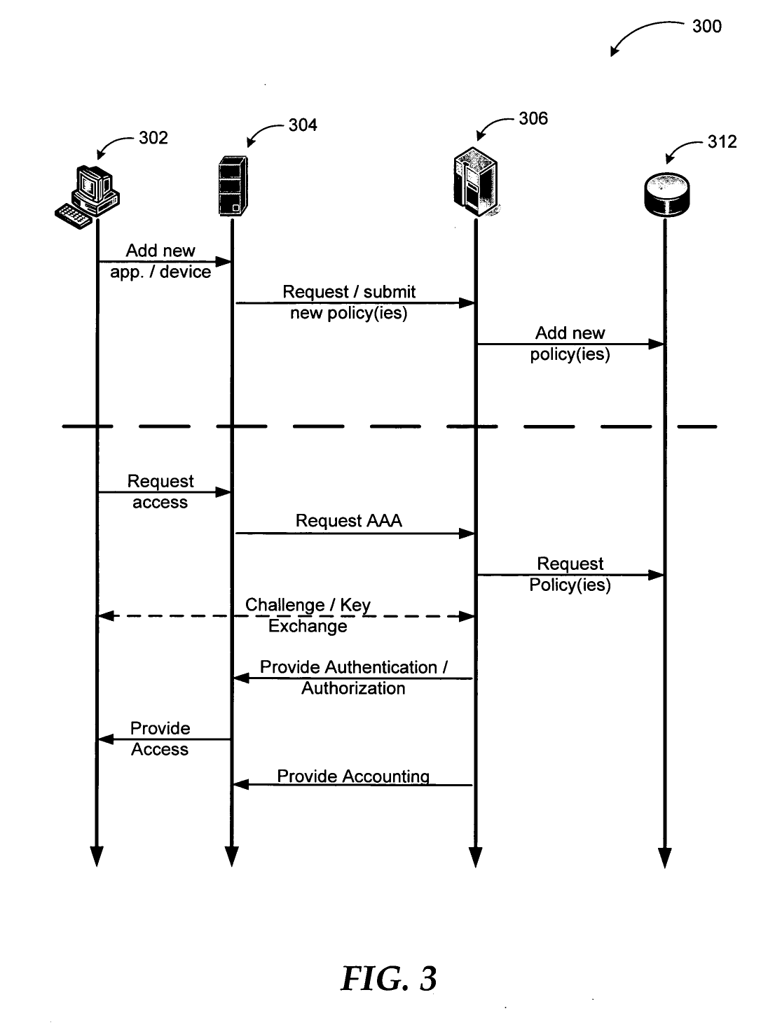

FIG. 3 illustrates action diagram 300 of interactions between a user, a network access server (NAS), and an Internet Access Service (IAS) server for creation and use of isolated policies. User 302 may include a person, a machine, a client application, a server application, and the like. User 302 and NAS 304 may communicate through a variety of means including, but not limited to, wired, wireless, infrared, and the like. IAS server 306 may include an integrated policy data store 312 or communicate with a remote data store to submit new policies, modify existing ones, and retrieve policies for authentication, authorization, and accounting purposes.

A first part of the interactions, shown above the dashed line, illustrate an example of generating new application and/or network access device level policies. User 302 initiates the process by reporting to NAS 304 that a new application or network access device is to be added with isolated policies. In response to this request, NAS 304 may submit a new policy associated with the new application or network access device to IAS server 306. In other embodiments, NAS 304 may request that a new policy be created for the new application or network access device.

According to some embodiments, the application(s) and/or network access device(s) may be indicated with an integer value assigned to a network access server type attribute. This attribute may be provided to the IAS server in a policy tag as part of a packet in network communication protocol. For example, an anywhere access gateway may be assigned “1”, a remote access virtual private network (VPN) application may be assigned “2”, a DHCP network device may be assigned “3”, a wireless access device may be assigned “4”, and the like. Of course, the indicators and their conveyance to the IAS server may be implemented in many other ways using the principles described herein.

Upon receiving the submitted policy or creating a new policy in response to the request from NAS 304, IAS server 306 may store the new policy and its association with the new application or network access device in data store 312 for subsequent retrieval.

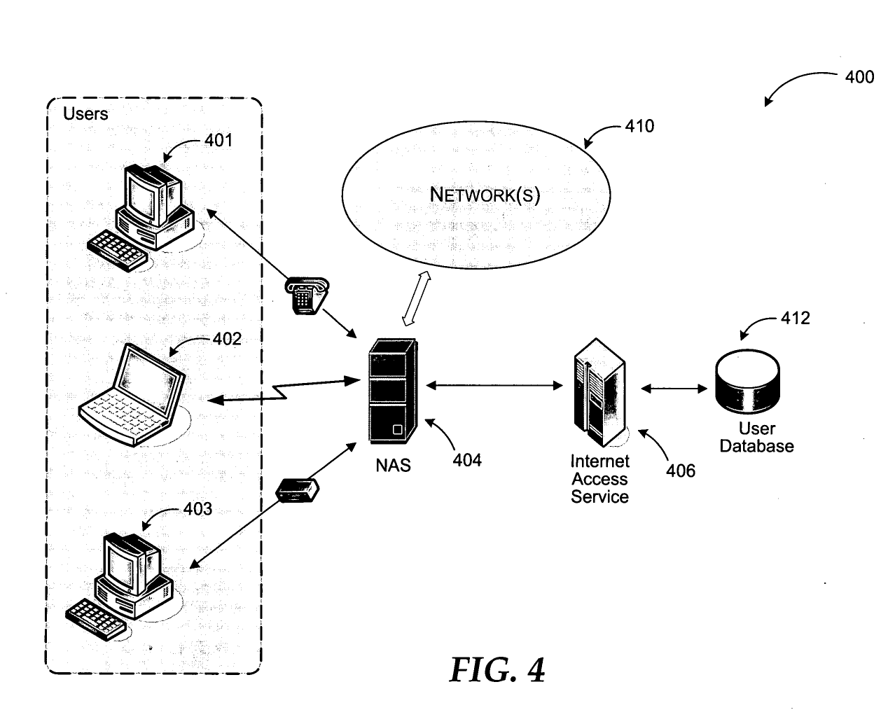

A second portion of the interactions, shown below the dashed line, illustrates an example of the use of isolated policies in access authentication, authorization, and accounting. The process begins with a request from user 302 for access to a network resource. The request is forwarded by NAS 304 to IAS server 306 in form of an AAA request. The AAA request includes an indication of the application or network access device associated with the user's access request. The indication may include the policy tag with the network access server type attribute described previously. IAS server 306 determines one or more applicable policies and retrieves them from data store 312. Following the retrieval of the policies, an authentication process may ensue depending on which protocol is used. Examples of authentication protocols are provided below in conjunction with FIG. 4. Such a process may include exchange of a challenge, a password, encryption keys, and the like.

Once compliance with the policy(ies) is confirmed, IAS server 306 may provide authentication to NAS 304. A similar process may be followed for authorization. In response to receiving confirmation of the authentication (and authorization), NAS 304 may provide access to user 302 for the requested network resource. In some embodiments, IAS server 306 may also provide accounting services to NAS 304 or other designated servers. Such services may include collecting and providing information associated with user's access duration, type, and the like. The isolated policy(ies) associated with the application and/or network device may also be used for defining parameters of the accounting operations.

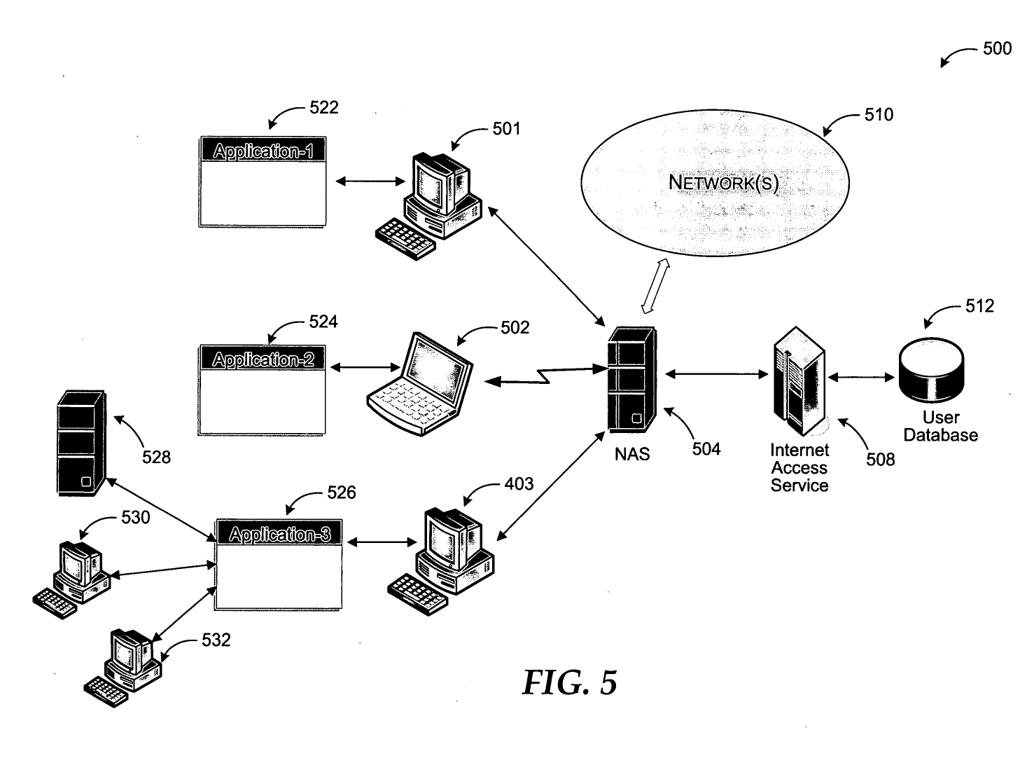

Referring now to the following figures, aspects and exemplary operating environments will be described. FIG. 4, FIG. 5, and the associated discussion are intended to provide a brief, general description of a suitable computing environment in which the invention may be implemented.

Referring to FIG. 4, a networked system where example embodiments may be implemented, is illustrated. System 400 may comprise any topology of servers, clients, Internet service providers, and communication media. Also, system 400 may have a static or dynamic topology. The term “client” may refer to a client application or a client device employed by a user to perform operations associated with accessing a networked system. Furthermore, the term “client” may also be used to refer to NAS 404 in relation to IAS server 406. While a network access system may include many more components, relevant ones are discussed in conjunction with this figure.

Network access server (NAS) 404 and IAS server 406 may also be one or more servers or programs on one or more server machines executing programs associated with network access tasks. Similarly, user database 412 may include one or more data stores, such as SQL servers, databases, non multi-dimensional data sources, file compilations, data cubes, and the like.

Network(s) 410 may include a secure network such as an enterprise network, an unsecure network such as a wireless open network, or the Internet. Network(s) 410 provide communication between the nodes described above. By way of example, and not limitation, network(s) 410 may include wired media such as a wired network or direct-wired connection, and wireless media such as acoustic, RF, infrared and other wireless media.

To validate and provide dial-up and remote access networking the Remote Authentication Dial-In User Service (RADIUS) industry standard was developed. A goal of the RADIUS standard is to ensure a secure authorization, identification, authentication, and accounting process of user accounts. According to a RADIUS compliant process, a client, typically network server used by a service provider, forwards user account information (e.g. username and password) to a RADIUS server. The RADIUS server authenticates the client request and validates the information submitted.

A specific example of RADIUS servers is Microsoft Windows 2000® provided RADIUS Server named the Internet Authentication Service (IAS). IAS provides services for receiving individual connection requests, authenticating, and authorizing the connection attempt, then returning all the data necessary for the RADIUS client to service the end user. In an ISP network environment, usually a network access server (NAS) 404 works as a client of an IAS server 406. The NAS is responsible for passing the user information to clustered IAS servers and then forwarding the result to the end user. There are a wide variety of different types of NAS providing access to different systems and networks, including a dial-up endpoint providing access to client devices via dial-up connection, a VPN concentrator serving a virtual private network, a wireless base station providing network access via wireless connection, a router, and a number of other devices that provide network access.

Various authentication protocols may be supported by the IAS server. The protocol in use is determined by the settings of the NAS device. The authentication protocol has to be correctly configured to allow end user connectivity. Some example protocols are:

Password Authentication Protocol (PAP)—The PAP authentication protocol passes a password as a text string from the end user to the NAS. The NAS forwards the password to the IAS Server using the configured shared secret as an encryption key.

Shiva Password Authentication Protocol (SPAP)—This protocol is used by Shiva remote access devices. SPAP may be less secure than CHAP or MS-CHAP, but more secure than PAP.

Challenge Handshake Authentication Protocol (CHAP)—This protocol uses MD5 algorithms to encrypt the challenge and the user's password. CHAP is used by many dial-up environments.

Microsoft Challenge Handshake Authentication Protocol (MS-CHAP®)—MS-CHAP is a version of CHAP that uses MD4 algorithms to encrypt the challenge and the user's password.

Extensible Authentication Protocol (EAP)—This protocol is an extension to Point-To-Point Protocol (PPP) that allows authentication methods to validate PPP connections. EAP is used is high-security environments. It supports user authentication through public key certificates and the smart card logon.

IAS, implementing RADIUS protocol, extends the operating system's network authentication capabilities by making it possible to implement plug-in DLLs that provide enhanced session control and accounting.

In an operation, an authenticating client (“user”) connecting to NAS 404 over any connection (e.g. user 401 through dial-up, user 402 through wireless, user 403 through DSL, and the like) may use the Point-to-Point Protocol (PPP). In order to authenticate the user, the NAS contacts a remote server running IAS. The NAS 404 and the IAS server 406 may communicate using the RADIUS protocol.

A NAS operates as a client of a server or servers that support the RADIUS protocol. Servers that support the RADIUS protocol are generally referred to as the RADIUS servers (in this case IAS server 406). The RADIUS client, that is, the NAS 404, passes information about the user to designated RADIUS servers, and then acts on the response that the servers return. The request sent by the NAS to the RADIUS server in order to authenticate the user is generally called an “authentication request.”

If a RADIUS server authenticates the user successfully, the RADIUS server returns configuration information to the NAS so that it can provide network service to the user. This configuration information is composed of “authorizations.”

The RADIUS server may also collect a variety of information sent by the NAS that can be used for accounting and for reporting on network activity. The RADIUS client sends information to designated RADIUS servers when the user logs on and logs off. The RADIUS client may send additional usage information on a periodic basis while the session is in progress. The requests sent by the client to the server to record logon/logoff and usage information are generally called “accounting requests.”

While the RADIUS server is processing the authentication request, it can perform authorization functions such as verifying the user's telephone number and checking whether the user already has a session in progress. The RADIUS server can determine whether the user already has a session in progress by contacting a state server. A RADIUS server can act as a proxy client to other RADIUS servers. In these cases, the RADIUS server contacted by the NAS passes the authentication request to another RADIUS server that actually performs the authentication. In a conventional system, the authentication and authorization is limited to the user as the registered person or the machine utilized by the user. Furthermore, the system may typically include a general policy engine to authenticate and authorize a request without providing a way to isolate a policy to an application. Thus, there is no policy isolation mechanism where a policy can be associated with an application or a network access device.

In a system according to embodiments, however, application and/or network access device level isolated policies may be implemented to provide the users greater freedom and flexibility as well as security to networked applications. As described above, specific applications or network access devices may be designated as an attribute value in a policy tag included in packets submitted to IAS server 406, which uses this information to retrieve application or network access device specific policies from user database 412 and perform AAA operation based on these isolated policies.

Many other configurations of computing devices, applications, data sources, data distribution and analysis systems may be employed to implement a network access management system with isolated policies.

FIG. 5 illustrates use of isolated policies for various scenarios in the networked system of FIG. 4. The basic components and operations of system 500 is similar to the likewise numbered components and operations of system 400 of FIG. 4.

In FIG. 5, user 501 is associated with application 1 (522), which is submitted through NAS 504 to IAS server 506 for authentication and authorization. Accordingly, isolated policies for application 1 (522) exist in user database 512. Similarly, user 502, communicating with NAS 504 over a wireless line, is associated with application 2 (524), which is also submitted through NAS 504 to IAS server 506 for authentication and authorization. Isolated policies for application 2 (524) may exist in user database 512 as well. If the associated policies do not exist or IAS server 506 is unable to decipher the network server type attribute indicating application 2, IAS server 506 may use a set of default policies for authenticating application 2.

User 503 is associated with application 3 (526), which is further associated with three other computing devices: server 528, computing device 530, and computing device 532. For example, application 3 may be a back-up application that coordinates data backup operations for the three listed devices. In this scenario, user database 512 may include multiple sets of policies based on application 3. For example, one policy may be based on application 3 being authenticated without any of the computing devices 528, 530, and 532. Another policy may be based on application 3 and any combination of its associated computing devices, because any one of these devices may gain access to the same resource as user 503 through application 3 (526).

The networked environments discussed in FIG. 4 and FIG. 5 are for illustration purposes only. Embodiments are not limited to the example applications, modules, or processes. A networked environment for implementing application and/or network access device level policies may be provided in many other ways using the principles described herein.

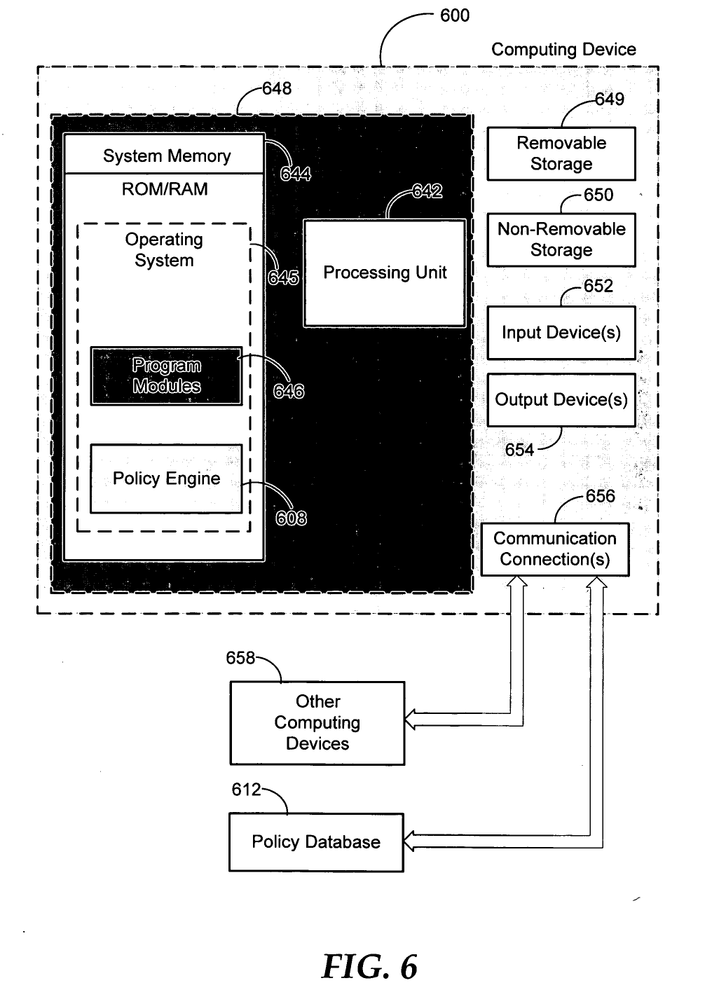

With reference to FIG. 6, one example system for implementing the embodiments includes a computing device, such as computing device 600. In a basic configuration, the computing device 600 typically includes at least one processing unit 642 and system memory 644. Computing device 600 may include a plurality of processing units that cooperate in executing programs. Depending on the exact configuration and type of computing device, the system memory 644 may be volatile (such as RAM), non-volatile (such as ROM, flash memory, etc.) or some combination of the two. System memory 644 typically includes an operating system 645 suitable for controlling the operation of a networked personal computer, such as the WINDOWS® operating systems from MICROSOFT CORPORATION of Redmond, Wash. The system memory 644 may also include one or more software applications such as program modules 646 and policy engine 608.

Policy engine 608 may work in a coordinated manner as part of a network AAA system in managing isolated policies. As described previously in more detail, policy engine 608 may determine compliance of an access request with predetermined policies at application and/or network access device level. Policy engine 608 may be an integrated part of an Internet access service or operate remotely and communicate with the IAS and with other applications running on computing device 600 or on other devices. Furthermore, policy engine 608 may be executed in an operating system other than operating system 645. This basic configuration is illustrated in FIG. 6 by those components within dashed line 648.

The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 649 and non-removable storage 650. Computer storage media may include volatile and nonvolatile, removable and non-removable media implemented in any method or technology for storage of information, such as computer readable instructions, data structures, program modules, or other data. System memory 644, removable storage 649 and non-removable storage 650 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of device 600. Computing device 600 may also have input device(s) 652 such as keyboard, mouse, pen, voice input device, touch input device, etc. Output device(s) 654 such as a display, speakers, printer, etc. may also be included. These devices are well known in the art and need not be discussed at length here.

The computing device 600 may also contain communication connections 656 that allow the device to communicate with other computing devices 658, such as over a network in a distributed computing environment, for example, an intranet or the Internet. Communication connection 656 may enable policy engine 608 to communicate with policy database 612, store and retrieve categorized policies at application and/or network access device level. Communication connection 656 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The claimed subject matter also includes methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

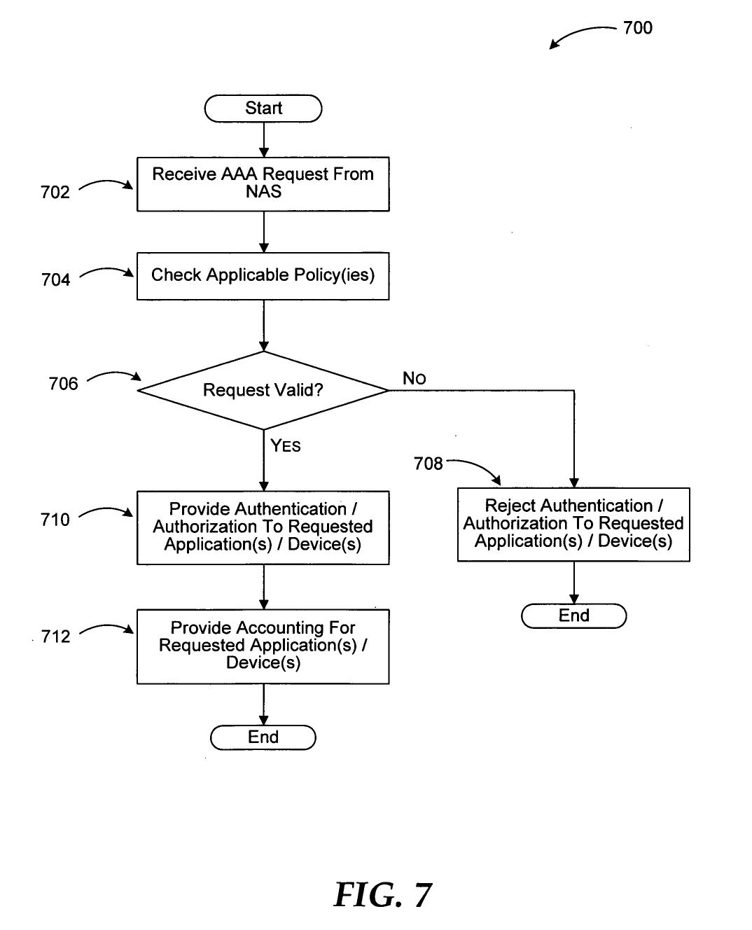

FIG. 7 illustrates a logic flow diagram for a process of using application and/or network access device level policies in a networked system. Process 700 may be implemented in a policy engine of an Internet access server such as policy engine 108 of FIG. 1.

Process 700 begins with operation 702, where an AAA request is received from a NAS. The request may include in form of a network access server type attribute an indication of an application or network access device for which isolated policies are to be applied. Processing advances from operation 702 to operation 704.

At operation 704, one or more applicable policies are determined. As mentioned above the policies may be determined based on the attribute associated with the application and/or network access device provided in a policy tag. If no indication is provided or the attribute cannot be resolved by the policy engine, a set of default policies may be applied. Processing proceeds from operation 704 to decision operation 706.

At decision operation 706, a determination is made whether the request is valid, in other words, whether the request complies with the applicable policies. If the request is invalid, a rejection of the authentication request may be provided to the requesting NAS (e.g. a NACK message) at the following operation 708. If compliance is determined, processing moves from decision operation 706 to operation 710.

At operation 710, the requesting NAS is notified of the authentication (e.g. ACK message). The authentication response may also include authorization. Because the request and applied policies are based on a specific application(s) or network access device(s), the authentication is also specific to the same specific application(s) or network access device(s). Processing advances from operation 710 to operation 712.

At operation 712, the IAS server that includes the policy engine may provide accounting services for the authenticated user access. Information associated with the accounting operations may be provided to the requesting NAS or another server or application. After operation 712, processing moves to a calling process for further actions.

The operations included in process 700 are for illustration purposes. Providing categorized policies at application and/or network access device level may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for managing access to a resource in a networked environment based on a security policy, the method comprising:
receiving a request for authentication and authorization from a network access server (NAS) for a user;
determining an applicable security policy in response the request, wherein the applicable security policy is associated with one of: an application and a network access device;
confirming compliance with the applicable security policy; and
providing a notification of the compliance to the NAS.

2. The method of claim 1, further comprising:
performing a set of accounting operations associated with the user's access to the resource.

3. The method of claim 1, further comprising:
if the compliance with the applicable security policy cannot be confirmed, providing a notification of failure to one of: authenticate and authorize to the NAS.

4. The method of claim 1, wherein the applicable security policy comprises a plurality of rules.

5. The method of claim 4, wherein the access to the resource is provided based on the plurality of rules.

6. The method of claim 1, wherein the applicable security policy is determined based on a network access server type attribute provided by the NAS with the request.

7. The method of claim 6, wherein the network access server type attribute includes one from a set of: a remote access server, a terminal server gateway, a DHCP server, a wireless access point, and a user defined server type; wherein a policy tag is used to apply a policy associated with a network access server type attribute.

8. The method of claim 6, further comprising:
if an applicable security policy cannot be determined based on the received network access server type attribute, applying a default security policy.

9. The method of claim 1, further comprising:
receiving one or more security policies associated with one or more network access server type attributes from one of: a NAS, a network administrator, and a user; and
storing the received security policies in a policy data store for subsequent retrieval.

10. The method of claim 9, wherein the applicable security policy is selected from a plurality of policies stored in the policy data store.

11. The method of claim 10, further comprising:
providing an adaptive user interface (UI) for administering the plurality of policies in the policy data store, wherein the UI is configured to provide access to the policies based on a credential.

12. The method of claim 11, wherein providing access to the policies includes filtering the policies to be accessed based on the credential.

13. The method of claim 1, further comprising:
using an authentication protocol in communicating the request and the notification in response to the request.

14. A computer-readable medium having computer executable instructions for providing policy isolation in managing network access authentication, the instructions comprising:
in response to a request for access to a network resource determining a policy among a plurality of policies stored in a policy data store, wherein the plurality of policies includes one or more categorized policies associated with one of: an application and a network access device;
determining compliance with the policy using an authentication protocol;
if the compliance is confirmed, providing a notification of authentication; and
if the compliance cannot be confirmed, providing a notification of failure to authenticate.

15. The computer-readable medium of claim 14, wherein the instructions further comprise:
performing authorization and accounting operations based on the request and the determined policy, wherein the policy is determined based on a network access server type attribute included in the request.

16. The computer-readable medium of claim 14, wherein the instructions further comprise:
providing a UI for managing the plurality of policies based on user credentials, wherein the UI is configured to provide access to selected policies depending on the user credentials for at least one from a set of: adding a new policy, modifying an existing policy, and removing an existing policy in association one of an application and a network access device.

17. A system for providing policy isolation in network authentication and authorization, comprising:
a policy engine configured to:
determine an applicable policy in response to a request by a user for access to a network resource from a NAS;
retrieve the applicable policy;
determine compliance with the applicable policy;
if the compliance is confirmed, authenticate the user; and
if the compliance is not confirmed, provide the NAS with a denial of authentication;
a policy data store configured to store a plurality of policies, wherein a portion of the plurality of policies is associated with one of: an application and a network access device; and
a user interface configured to:
enable access to at least a portion of the plurality of policies based on one or more credentials for at least one from a set of: adding a new policy, modifying an existing policy, and removing an existing policy in association one of an application and a network access device.

18. The system of claim 17, wherein the policy engine is integrated into an Internet Access Service (IAS) server.

19. The system of claim 17, wherein the policy engine is further configured to perform at least one of authorization operations and accounting operations based on the applicable policy in association one of an application and a network access device.

20. The system of claim 17, wherein the policy engine is further configured to determine the applicable policy based on a network access server attribute as part of a received data packet.
